(19) United States
(12) Patent Application Publication
(10) Pub. No.: US 2019/0050001 A1
(43) Pub. Date: Feb. 14, 2019

(54) SYSTEM AND METHOD FOR PRECISE DETERMINATION OF A REMOTE GEO-LOCATION IN REAL TIME

(71) Applicant: EYESATOP LTD., NAHAM (IL)

(72) Inventors: YARIV GUEZ, GEDERA (IL); EINAV HARAZI, NAHAM (IL)

(73) Assignee: EYESATOP LTD., NAHAM (IL)

(21) Appl. No.: 15/757,502

(22) PCT Filed: May 1, 2016
(86) PCT No.: PCT/IL2016/050450

§ 371 Date: Mar. 5, 2018

(51) Int. Cl. G05D 1/10; G08G 5/00; H04W 4/02; G05D 1/00

(52) U.S. Cl. CPC G05D 1/104; G05D 1/0094; H04W 4/025; G08G 5/0043

(57) ABSTRACT

A system for real-time remote precision geo-pointing. The system includes at least two alignable aircraft, maneuver-able so as to create a line of sight (LOS) alignment with a target; a CPU/computer configured to calculate the position of the target based on information from the at least two alignable aircraft; a mechanism for conveying the geo-location of the alignable aircraft, when the aircraft are aligned, to the CPU/computer; and a verification and maintenance mechanism configured to verifying and maintain the LOS alignment.

### FIELD OF THE INVENTION

The present invention relates to geo-location, more specifically to real-time remote geo-pointing/geo-locating.

### BACKGROUND OF THE INVENTION

The determination of a remote target's precise geo-location can be important in a variety of situations, for example rescue or military situations. Typically geo-referenced aerial images, orthophotos, laser and/or radar distance and range devices are used to make geo-location determinations.

So-called “geo-referencing” devices either use passive means (based on geo-located images) or active means (based on emitting energy in the form of radar or laser directed towards targets).

However, both of these types of instruments are not adequately fit for most ground level uses, where the observer is facing a target in the horizon and especially if the target is in urban areas.

### SUMMARY OF THE INVENTION

It is an object of the present invention to provide a real-time, precise and accurate, machine readable, quantitative geo-location of a remote target that utilizes one or more aerial constellations of aircraft.

According to embodiments of one aspect of the present invention there is provided a system for precise determination for a remote geo-location in real time. The system includes: at least two alignable aircraft, maneuver-able so as to create a line of sight (LOS) alignment with a target; a CPU/computer configured to calculate the position of the target based on information from the at least two alignable aircraft; a mechanism for conveying the geo-location of the alignable aircraft, when the aircraft are aligned, to the CPU/computer; and a manual or automatic mechanism configured for verifying and maintaining the LOS alignment.

In some embodiments, the CPU/computer is associated with a ground control station. In some embodiments, the CPU/computer is configured to aid in the LOS alignment of the at least two alignable aircraft.

According to embodiments of one aspect of the present invention there is provided a method of precisely determining the remote geo-location in real time of a target. The method includes the steps of aligning at least two alignable aircraft with the target; transmitting location data from the aircraft to a CPU/computer; and calculating the geo-position of the target.

The term “location” is defined in respect to the earth and can be a two-dimensional (2-D) geo-location grid (on the face of the earth/geo-location “datum”). The term “height” used hereinbelow is with respect to the geo-location (datum) and is defined as the distance from the datum, typically Mean Sea Level. The term “3-D location” is defined as a location that includes the 2-D location and the height.

It is a particular feature of the present invention to provide both an improved 2-D geo-location and 3-D geo-location system and method.

The system allows precise measurement of a remote target's geo-location by maneuvering the aircraft above the target thus creating a line-of-sight (LOS) that mathematically passes through the target's geo-location, enabling, with knowledge of the target's MSL height (i.e. where the base of the target is located). The lower aircraft can be considered a crosshair for the alignment process.

In some embodiments, the control station can also process data from three or more aircraft, enabling multiple LOSs to be calculated thus enabling stereoscopic and multi-scopic calculations without needed knowledge of target's MSL height.

In some embodiments, the system includes an imaging device (e.g. camera, hereinafter in the specification and claims “camera”), a computer screen or the like, used to display at least one of the aircraft. In some embodiments, the camera is coupled with a first (higher) aerial transmitter of the higher aircraft. In some embodiments, the camera could be associated with the lower aircraft, wherein the camera can view both upward to the higher aircraft and downward to the target (e.g. a 360-degree camera or constituted by two or more cameras).

In some embodiments, the system includes an “aerial image-transmitter” attached to one of the aircraft for transmitting images; at least two geo-positioning devices (i.e. GPS device or any other device for determining the device's geo-position) respectively associated with the aircraft and coupled with a second transmitter for transmitting the device's geo-position (which may be referred to as an “aerial geo-transmitter”) where the first transmitter and the second transmitter are attached to a different aircraft; a processor/CPU (e.g. a control station located at one of the aircraft or at a remote control station, such as a ground station) coupled to a data storage device, a tele-receiver for collecting data transmitted from the aircraft and a station-display for identifying the target and calculating its precise location; a control-device (e.g. as part of a ground control station) having one or more actionable interface mechanisms (i.e. buttons, sticks, levers) for a user to interface with the control station; and for cases when the control station also remotely controls at least one of the aircraft, a tele-transmitter device to tele-transmit data from the control station to the aircraft.

In some embodiments, instead of the GPS device being coupled with a second transmitter for transmitting the device's geo-position (“aerial geo-transmitter”), the GPS itself further includes a GPS data transmitter or antenna.

### BRIEF DESCRIPTION OF THE DRAWINGS

The invention may be more clearly understood upon reading of the following detailed description of non-limiting exemplary embodiments thereof, with reference to the following drawings, in which:

FIGS. 1 and 2 are schematic depictions of a geo-pointing system in accordance with embodiments of the present invention, where aircraft of the system are alignable directly over a target;

FIG. 3 is a schematic depiction of another embodiment of the system, where aircraft of the system are alignable at an angle over the target;

FIGS. 4-7 are schematic depictions of other embodiments of the system, illustrating various remote control stations and line-of-sight (LOS) configurations.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

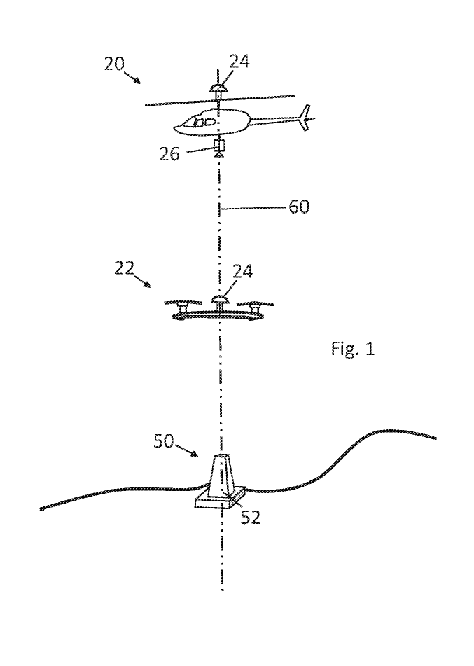

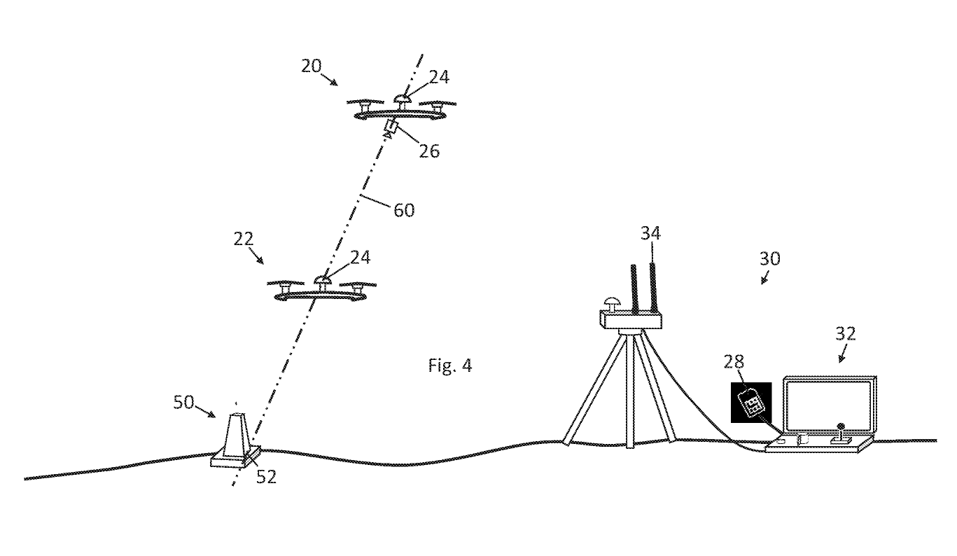

FIG. 1 shows a geo-pointing system in accordance with embodiments of the invention for precise, real-time calculation/determination of the location/position of a remote target 50. The system includes aircraft, specifically a first, higher altitude, aircraft 20 and a second, lower altitude, aircraft 22; aerial geo-transmitters 24 (one for each aircraft/aircraft); a camera 26 associated with higher altitude aircraft 22; an aircraft positioning (including alignment) and location mechanism 32 (FIG. 4), which can be a part of the aforementioned aerial geo-transmitters 24, to determine the location of the aircraft (e.g. a GPS; an aircraft location system from a ground station and the like, all of which in some embodiments further includes an altimeter, not shown); and optionally/advantageously a CPU/computer 28 (for example to automate the process and process collected data from aircraft positioning and location mechanism 32 and data from the aerial geo-transmitters 24). In some embodiments, aircraft positioning and location mechanism 32 can be thought of as a LOS-alignment mechanism.

Typically, aircraft 20 and 22 are aircraft that can hover, such as helicopters (as aircraft 20 is depicted in FIG. 1) or drones (as aircraft 22 is depicted in FIG. 1). However, it should be understood that non-hovering aircraft could be used, mutatis mutandis; and of course the aircraft can be of the same type, e.g. helicopter, drone, non-hovering, or any combination thereof.

One or both of aircraft 20 and 22 can be manned in order to control their position, however in some embodiments, one or both of the aircraft is remotely controlled. It should be understood that in embodiments where there is human control of the alignment process, camera 26 typically includes or has associated therewith a display.

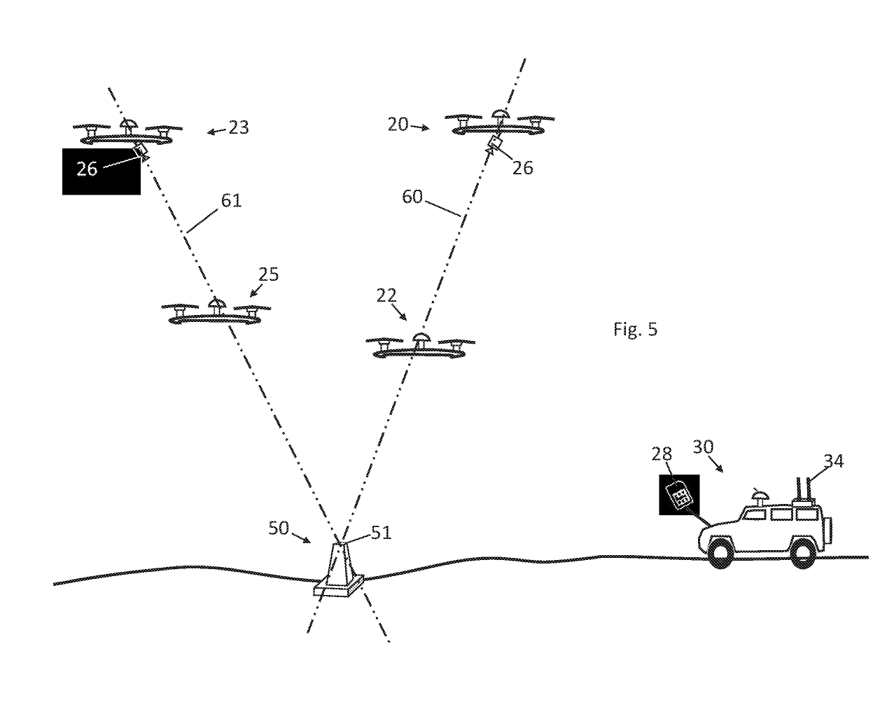

In some embodiments, described below, one or both of the aircraft 20, 22 are non-manned and the one remaining manned aircraft, or a control station 30, such as a remote ground station; FIGS. 5-7) is configured to control and align the aircraft.

FIG. 4 illustrates an embodiment of the system wherein control station 30 is a remote control station and includes a transceiver 34 (i.e. aircraft positioning/location mechanism 32, or component thereof) to control the positions of aircraft 20 and 22. CPU/computer 28 can be located at remote control station 30, as illustrated.

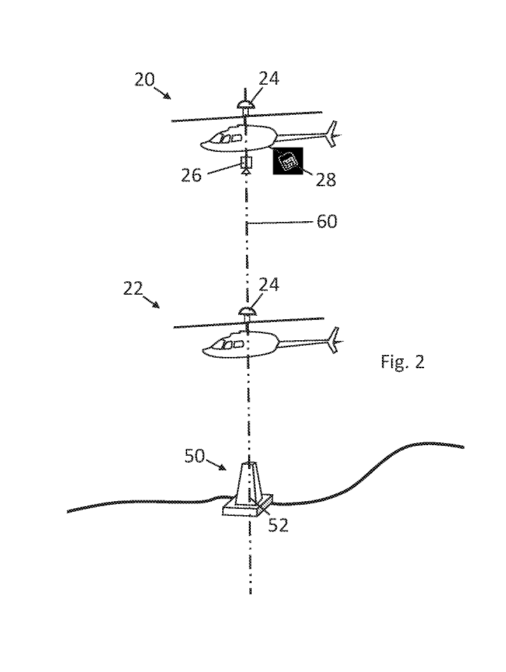

If aircraft 20 and 22 are aligned directly/vertically above target 50, as illustrated in FIGS. 1 and 2, and the GPS coordinates of the aircraft are known, then the geo-location of the target is thus known, the same as the aircraft. The MSL height of the target need not be known in order to calculate the two-dimensional (2-D) geo-location.

In order to calculate the precise remote geo-location of target 50, aircraft 20 and 22 are positioned in such a way as to create a line-of-sight (LOS) 60 with the target. One method of aligning aircraft 20 and 22 with target 50 is to position higher aircraft 20 directly above target 50 (with camera 26 directed toward the target); then positioning lower altitude aircraft 22 below camera 26 of higher altitude aircraft 20 so that the lower altitude aircraft blocks target 50. To increase the precision of the LOS 60, lower altitude aircraft 22 can be lowered, while continuing to position aircraft 22 to continue to block target 50 from camera 26 (i.e. in the LOS). Such a method ensures the LOS 60 arrangement of the aircraft 20 and 22, in particular the respective geo-transmitters 24. The above alignment and positioning can be either controlled by the manned aircraft 20 and/or 22, such as by the pilot(s) or navigators or by an automatic alignment instrument, or by an automatic flight control system.

In some embodiments, described below, one or both of the aircraft 20, 22 are non-manned and the one remaining manned aircraft, or a control station 30, such as a remote ground station—FIGS. 5-7) is configured to control and align the aircraft.

It should be understood that with data indicating the global position of aircraft 20 and 22, and a LOS 60 configuration between the aircraft and target 50, the global position of target 50 can be calculated by CPU/computer 28. As such, no details of the actual calculation will be described.

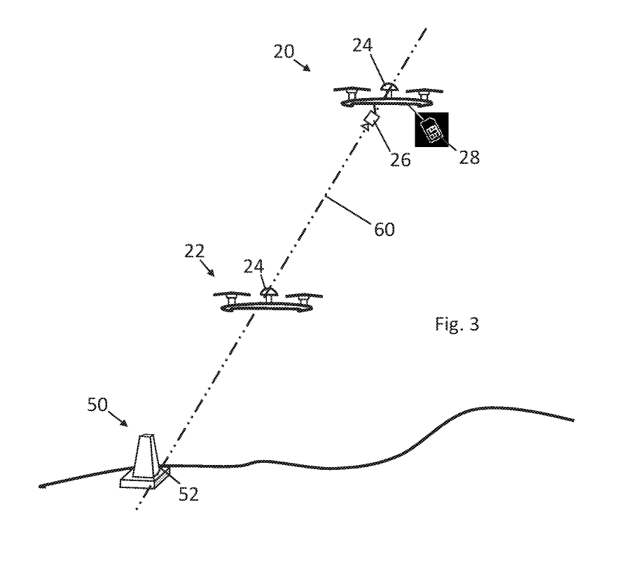

FIG. 3 shows an embodiment where higher aircraft 20 and lower aircraft 22 are not aligned directly above target 50, rather the aircraft are aligned in a LOS 61 at an angle to target 50. In order to calculate the 2-D geo-location of the target 50, the height of target 50 must be known (e.g. by a mean sea level altitude reference, such as a computer readable topographic map) or calculated using multiple lines of sight, as will be described below. Again, once these data from the alignment and the altitude are determined, calculating the geo-location can be performed as known.

FIG. 5 shows another embodiment wherein the MSL height is calculable by the system and includes multiple lines of sight, LOS 60 and LOS 61. In this embodiment, four manned or unmanned aircraft, namely higher aircraft 20; lower aircraft 22; auxiliary higher aircraft 23; and auxiliary lower aircraft 25 are used to produce LOS 60 and LOS 61. With such a configuration, the aircraft are used to produce LOS 60 and LOS 61 so they intersect at any desired portion 51 of target 50, which is in contrast to the situation where a topographical map or the like is used. Again, once the alignment of the aircraft to form LOS 60 and LOS 61 is verified to intersect on target 50, the geo-location of the target can be calculated, including the MSL height of the target, as known. In FIG. 5, remote control station 30 is illustrated as a land vehicle.

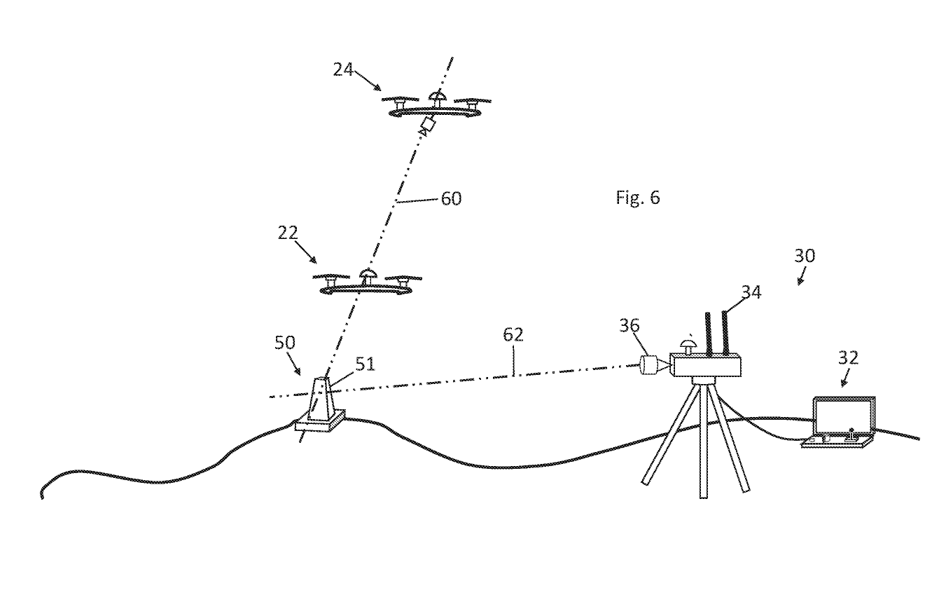

FIG. 6 illustrates another embodiment using multiple LOSs, such as LOS 60 and LOS 62, and LOS 62 is produced from a direct (LOS) view from a land survey camera 36, typically a control station land survey camera.

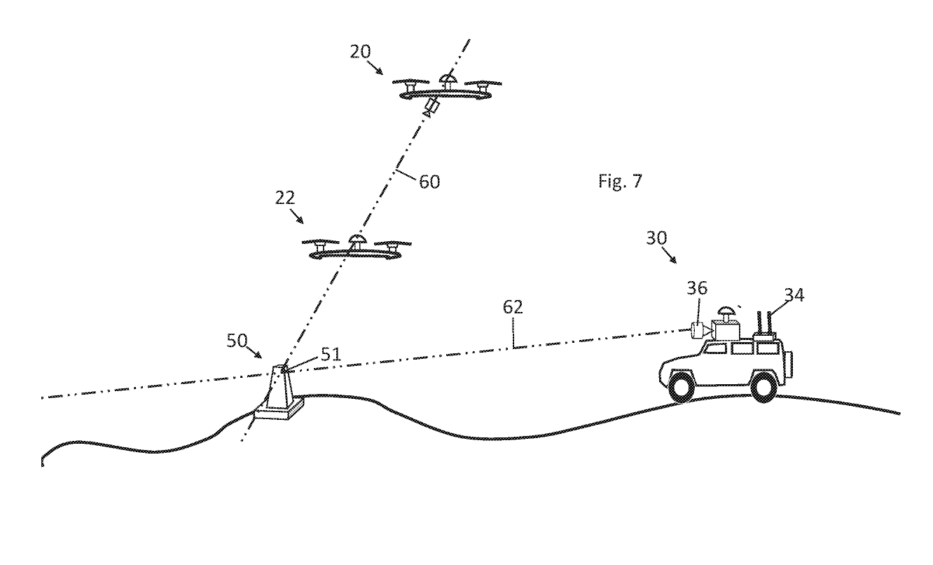

FIGS. 6 and 7 show embodiments of the system where multiple lines of sight. LOS 60 and additional LOS 62 are used to calculate the 2-D geo-location, and a 3-D geo-location (i.e. including the MSL height as well) can also be calculated with these embodiments.

In FIGS. 4-7, aircraft 20 and 22 (and in some embodiments aircraft 23 and 25 as well) are positioned (by using a control station 30, in particular the CPU/computer 28 thereof, or any method or device) in an LOS alignment with target 50, and the LOS alignment is calculated (and may also be controlled) using the control station. Control station 30 can be located either on one of the aircraft 20, 22, 23 or 25 or remotely. The target's MSL height can be input to the system or calculated using an additional LOS from a land survey or other ground-to-ground LOS systems (or auxiliary aircraft 23 and 25).

In some embodiments, the system aircraft positioning and location mechanism 32 (illustrated in FIG. 6 by an exemplary screen with associated alignment controls), for aligning the aircraft 20 and 22 in a LOS 60 manner with target 50, can be used automatically, whereby the aircraft 20 and 22 need not be manned. In some embodiments, aircraft positioning and location mechanism 32 may be an on-board alignment mechanism operably connected to at least one of the aircraft 20 and 22 and controllable by a manned-aircraft operator; while in some embodiments via a remote control station 30, which may be by a remote operator or automated. Additionally or alternatively, an additional line of sight can be used, which is described below.

Information regarding the geo-location can be transmitted using aerial geo-transmitters 24. The transmitted geo-locations can be received by control station 30. In embodiments where control station 30 is remote from the aircraft the transmitted data is collected by transceiver 34 of the control station 30. In other embodiments where control station 30 is carried on one of the aircraft 20 or 22, that aircraft's aerial geo-transmitter 24 can be directly connected to control station 30 without a need for tele-transmitting.

The system, including control station 30 and aircraft 20, 22 can also be configured in hybrid embodiments that combine LOS information from commonly used devices (e.g. land survey or ground stationed reconnaissance instruments). As illustrated in FIG. 6 and FIG. 7, LOS 62 produced by land survey camera 36 may be mounted on a tripod (or vehicle, building, pole, etc.), and data from land survey camera 36 is transferred to control station 30. Thus, together with LOS 60 (created by aircraft 20 and 22) the geo-location 52 of target 50 is calculated by control station 30, in particular CPU/computer 28 without the need to input the target's MSL height.

It will also be understood that CPU/computer 28 will be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

Thus there is provided a system including an alignable constellation of aircraft (and/or alignable ground stations or combination thereof), such that at least one of the aircraft/ground stations is used as crosshairs, for determining a precise geo-location of a remote target. In all but one particular constellation where the aircraft are aligned directly and vertically above a target, the altitude of the target must be determined. Determining the altitude can be achieved by one of two approaches; either the altitude is “pre-determined” (i.e. received from an outside source such as database, another system etc.); or calculated by the system (CPU/computer), by way of the use of more than one LOS).

The present method entails producing an LOS alignment of aircraft (or land survey cameras or a combination of aircraft and one or more land survey cameras) either: directly/vertically above a target and then noting or transmitting the GPS location of the aircraft/land survey cameras; or, producing multiple (typically two) alignment of aircraft (or land survey cameras or a combination of aircraft and one or more land survey cameras) so that those multiple LOSs intersect at the target, determining the altitude of the target (e.g. by data input from a digital topographical map or the like; or calculated by the system (CPU/computer), and then calculating the target's geo-location.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A system for real-time remote precision geo-pointing comprising:
at least two alignable aircraft, maneuver-able so as to create a line of sight (LOS) alignment with a target;
a CPU/computer configured to calculate the position of the target based on information from the at least two alignable aircraft;
a mechanism for conveying the geo-location of the alignable aircraft, when the aircraft are aligned, to the CPU/computer; and
a manual or automatic mechanism configured for verifying and maintaining the LOS alignment.

2. The system of claim 1, wherein the CPU/computer is associated with a ground control station.

3. The system of claim 1, wherein the CPU/computer is configured to aid in the LOS alignment of the at least two alignable aircraft.

4. A method of determining the real-time remote precision geo-position of a target comprising:
aligning at least two alignable aircraft with the target;
transmitting location data from the aircraft to a CPU/computer; and
calculating the geo-position of the target.
